(19) United States
(12) Patent Application Publication
(10) Pub. No.: US 2009/0281672 A1
(43) Pub. Date: Nov. 12, 2009

(54) WEATHER RESPONSIVE IRRIGATION SYSTEMS AND METHODS

(76) Inventor: Reza Pourzia, Oak Park, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/364,894

(22) Filed: Feb. 3, 2009

Related U.S. Application Data
(60) Provisional application No. 61/025,895, filed on Feb. 4, 2008.

(51) Int. Cl. G05D 7/06

(52) U.S. Cl. 700/284

(57) ABSTRACT

Irrigation control systems are described. In a number of embodiments, the irrigation control systems include a wireless irrigation controller that activates valves within an irrigation system and can wirelessly communicate with an access point. In several embodiments, the irrigation control system includes an ASP server that obtains weather information and can query irrigation controllers for information. In many embodiments, the ASP server aggregates information regionally and can provide water authorities with information concerning water usage and water savings. In further embodiments, the ASP server can provide access to authorized third parties, such as landscape contractors, enabling the third parties to remotely adjust the baseline watering schedule. In several embodiments, the ASP server uses information collected from an irrigation control system to provide one or more users associated with the irrigation control system with relevant information and/or marketing materials.

### RELATED APPLICATION

This application claims priority to U.S. Provisional Application No. 61/025,895 filed Feb. 4, 2008, the disclosure of which is incorporated herein by reference.

### BACKGROUND

The present invention relates generally to automated irrigation systems and more specifically to automated irrigation systems that are wirelessly accessible.

Irrigation can be used to promote the growth of plants. The amount of water required to adequately irrigate plants can vary depending upon a number of conditions including the species of plant, soil type and weather. A number of automated irrigation systems have been proposed that attempt to modify the amount of water used to irrigate plants based upon these conditions. Several systems rely on the use of a centralized server to control a number of network connected irrigation systems. In other systems, a local controller modifies watering programs based upon information collected using rain sensors.

### SUMMARY OF THE INVENTION

Irrigation control systems are disclosed that include irrigation controllers, which have irrigation schedules that are modified based on weather information. In a number of embodiments, the irrigation controllers are automatically bound to an access point and can respond to requests for information. In many embodiments, an application server collects information concerning the water usage of each irrigation controller. The application server can enable modifications to the irrigation schedule of an irrigation controller by third parties such as landscapers and water authorities. In several embodiments, the application server aggregates information and can enforce water usage restrictions.

One embodiment of the invention includes an irrigation controller configured to control an irrigation system, where the irrigation controller is configured to communicate with an access point via a local bi-directional communication network, a personal computer connected to the access point and to a communication network, where the personal computer is configured to communicate with the irrigation controller via the access point, a weather server configured to communicate with the personal computer via the communication network, an application server configured to communicate with the personal computer via the communication network, and a user device configured to communicate with the application server via the communication network. In addition, the irrigation controller is configured with a baseline schedule for controlling the irrigation system, the irrigation controller is configured to maintain information concerning water usage, the personal computer is configured to obtain weather information from the weather server, modify the baseline irrigation schedule using at least the weather information, and to provide the irrigation controller with the modified irrigation schedule via the access point, the personal computer is configured to obtain information including water usage information from the irrigation controller via the access point, the application server is configured to obtain information including information concerning water usage of an irrigation controller from the personal computer via the communication network, and the user device is configured to obtain information including information concerning water usage of the irrigation controller from the application server via the communication network.

In a further embodiment, the irrigation controller is associated with a user account maintained by the application server.

In another embodiment, the server maintains access information associated with the user account and the user device is configured to access the user account using the access information and to obtain user account information from the application server.

In a still further embodiment, the application server obtains the current irrigation schedule of the irrigation controller from the personal computer via the communication network, the user device is configured to retrieve the current irrigation schedule of the irrigation controller from the application server and to provide the application server with a modified irrigation schedule via the communication network, the application server is configured to provide the modified irrigation schedule to the personal computer via the communication network, and the personal computer is configured to provide the modified irrigation schedule to the irrigation controller via the access point.

Still another embodiment also includes at least one additional irrigation controller configured to communicate with the access point via the local bi-directional communication network. In addition, the at least one additional irrigation controller is also associated with the user account, the application server is configured to obtain information including information concerning water usage of each of the at least one additional irrigation controllers from the personal computer, and the application server is configured to aggregate water usage information across all of the irrigation controllers associated with the user account.

A yet further embodiment also includes a second irrigation controller configured to communicate with a second access point via a second local bi-directional communication network, and a second personal computer connected to the second access point and to the communication network, where the second personal computer is configured to communicate with the second irrigation controller via the second access point. In addition, the application server is configured to obtain information including information concerning water usage of the second irrigation controller from the second personal computer, and the second irrigation controller is associated with a second user account maintained by the application server.

In yet another embodiment, the application server is configured to aggregate water usage information across multiple user accounts.

In a further embodiment again, the server maintains access information associated with a third user account, the first and second user accounts include permission information granting the third user account access to irrigation controllers associated with a user account, and the user device is configured to access the third user account using the access information and to obtain information concerning the first and second irrigation controllers from the application server.

In another embodiment again, the user device is configured to retrieve the current irrigation schedule of the second irrigation controller from the application server and to provide the application server with a modified irrigation schedule for the second irrigation controller via the communication network, the application server is configured to provide the modified irrigation schedule to the second personal computer via the communication network, and the second personal computer is configured to provide the modified irrigation schedule to the second irrigation controller via the second access point.

In a further additional embodiment, the server maintains geographic information concerning each irrigation controller, and the server is configured to aggregate water usage information across all irrigation controllers within a geographic area.

In another additional embodiment, each user account includes associated contact information, and the server is configured to determine information relevant to the user based upon the user account information and provide the information to the user using the contact information.

In a still yet further embodiment, the server is configured to provide the personal computer with one or more irrigation limits via the communication network, and the personal computer is configured to generate a limited baseline irrigation schedule that does not violate the one or more irrigation limits and to provide the limited baseline schedule to the irrigation controller via the access point.

In still yet another embodiment, the personal computer is configured to modify the limited baseline irrigation schedule in response to weather information so that the modified irrigation schedule does not violate the one or more irrigation limits.

In a yet further embodiment again, the weather server and the application server are the same server.

Yet another embodiment again also includes at least one sensor configured to communicate sensor information to the access point via the local bi-directional communication network. In addition, the personal computer is configured to update the baseline irrigation schedule using at least the sensor information received via the access point.

In a yet further additional embodiment, at least one of the sensors is a moisture sensor.

In yet another additional embodiment, at least one of the sensors is a flow meter.

In a still further embodiment again, the personal computer is configured to graphically display water savings achieved through modifications to the baseline irrigation schedule.

In still another embodiment again, the irrigation controller includes an erasable non-volatile memory containing firmware, the application server is configured to distribute new firmware for the irrigation controller to the personal computer via the communication network, the personal computer is configured to provide the new firmware to the irrigation controller via the access point, and the irrigation controller is configured to load the new firmware into the erasable non-volatile memory.

A still further additional embodiment includes an access point connected to a communication network via a router, an irrigation controller configured to control an irrigation system, where the irrigation controller is configured to communicate with an access point via a local bi-directional communication network, a weather server configured to communicate with the access point via the communication network, an application server configured to communicate with the access point via the communication network, and a user device configured to communicate with the application server via the communication network. In addition, the irrigation controller is configured with a baseline irrigation schedule for controlling the irrigation system, the irrigation controller is configured to maintain information concerning water usage, the access point is configured to obtain weather information from the weather server via the router, modify the baseline irrigation schedule using at least the weather information, and to provide the irrigation controller with the modified irrigation schedule via the local bi-directional communication network, the access point is configured to obtain information including water usage information from the irrigation controller via the local bi-directional communication network, the application server is configured to obtain-information including information concerning water usage of an irrigation controller from the access point via the communication network, and the user device is configured to obtain information including information concerning water usage of the irrigation controller from the application server via the communication network.

Still another additional embodiment includes an access point connected to a communication network via a router, an irrigation controller configured to control an irrigation system, where the irrigation controller is configured to communicate with an access point via a local bi-directional communication network, an application server configured to communicate with the access point via the communication network, a weather server configured to communicate with the application server via the communication network, and a user device configured to communicate with the application server via the communication network. In addition, the irrigation controller is configured with a baseline irrigation schedule for controlling the irrigation system, the irrigation controller is configured to maintain information concerning water usage, the application server is configured to obtain weather information from the weather server, modify the baseline irrigation schedule using at least the weather information, and to provide the irrigation controller with the modified irrigation schedule via the access point, the application server is configured to obtain information including information concerning water usage from the irrigation controller via the access point, and the user device is configured to obtain information including information concerning water usage of the irrigation controller from the application server via the communication network.

### BRIEF DESCRIPTION OF THE DRAWINGS

FIG. 1 is a network diagram showing an irrigation control system including an irrigation controller that communicates with a personal computer via an access point in accordance with an embodiment of the invention.

FIG. 2 is a network diagram showing an irrigation control system including an e-commerce server and a user device that can communicate with an ASP server in accordance with an embodiment of the invention.

FIG. 3 is a semi-schematic circuit diagram of an irrigation controller in accordance with an embodiment of the invention.

FIG. 4 is a semi-schematic circuit diagram of an access point in accordance with an embodiment of the invention.

FIG. 5 is a conceptual diagram illustrating a client application that can be used to configure a personal computer in accordance with an embodiment of the invention.

FIG. 6 is a flow chart showing a process for providing a baseline irrigation schedule to an irrigation controller in accordance with an embodiment of the invention.

FIG. 7 is a flow chart showing a process for automatically binding an irrigation controller to an access point in accordance with an embodiment of the invention.

FIG. 8 is a flow chart showing a process for modifying a baseline irrigation schedule in accordance with an embodiment of the invention.

FIG. 9 is a flow chart showing a process for providing a modified irrigation schedule to an irrigation controller in accordance with an embodiment of the invention.

FIG. 10 is a flow chart showing a process for replacing the firmware of an irrigation controller using firmware distributed via a wireless network in accordance with an embodiment of the invention.

FIG. 11 is a flow chart showing a process for generating a graphical display illustrating a reduction in water usage achieved in accordance with an embodiment of the invention.

FIG. 12 is a flow chart showing a process for generating a report summarizing reductions in water usage within a geographic area in accordance with an embodiment of the invention.

FIG. 13 is a flow chart showing a process for modifying a baseline irrigation schedule to comply with water usage restrictions in accordance with an embodiment of the invention.

FIG. 14 is a flow chart showing a process for accessing a user account maintained on an application server and modifying the baseline irrigation schedule of irrigation controllers associated with the account.

FIG. 15 is a flow chart showing a process for determining information to provide to users based upon user information collected by an application server in accordance with an embodiment of the invention.

FIGS. 16a and 16b illustrate a flow chart showing a process for displaying contextually relevant advertising within a user interface that can be used to modify the irrigation schedule of an irrigation controller in accordance with an embodiment of the invention.

### DETAILED DESCRIPTION OF THE INVENTION

Turning now to the drawings, irrigation control systems in accordance with embodiments of the invention are shown. The irrigation control systems include a wireless irrigation controller that activates valves within an irrigation system and can wirelessly communicate with an access point. In operation, the irrigation control system possesses a baseline irrigation schedule and modifies the irrigation schedule in response to weather information obtained via the Internet. In several embodiments, the irrigation controller and/or an access point wirelessly communicates with one or more sensors, such as moisture sensors and flow meters, which provide information that can be further used to modify the baseline schedule.

In a number of embodiments, the irrigation control system includes an application or ASP server that can query irrigation controllers for information. In several embodiments, the ASP server aggregates information regionally and can provide municipal authorities with information concerning water usage and water savings and provides water authorities with the ability to automatically incorporate water restrictions into irrigation schedules. In other embodiments, the ASP server can provide access to authorized third parties, such as landscape contractors, enabling the third parties to remotely adjust the baseline watering schedule. In several embodiments, the ASP server uses information collected from an irrigation control system to provide one or more users associated with the irrigation control system with relevant information and/or marketing materials.

### Irrigation Control Systems

A variety of different architectures can be used to implement an irrigation control system in accordance with an embodiment of the invention. In many embodiments, the irrigation control system includes a local irrigation controller that controls valves in an irrigation system to deliver water to one or more irrigation zones in accordance with a schedule known as an irrigation schedule. The local irrigation controller is configured with a baseline irrigation schedule and possesses the ability to receive modifications to the baseline irrigation schedule that are responsive to weather conditions. A number of irrigation control systems in accordance with embodiments of the invention are discussed below.

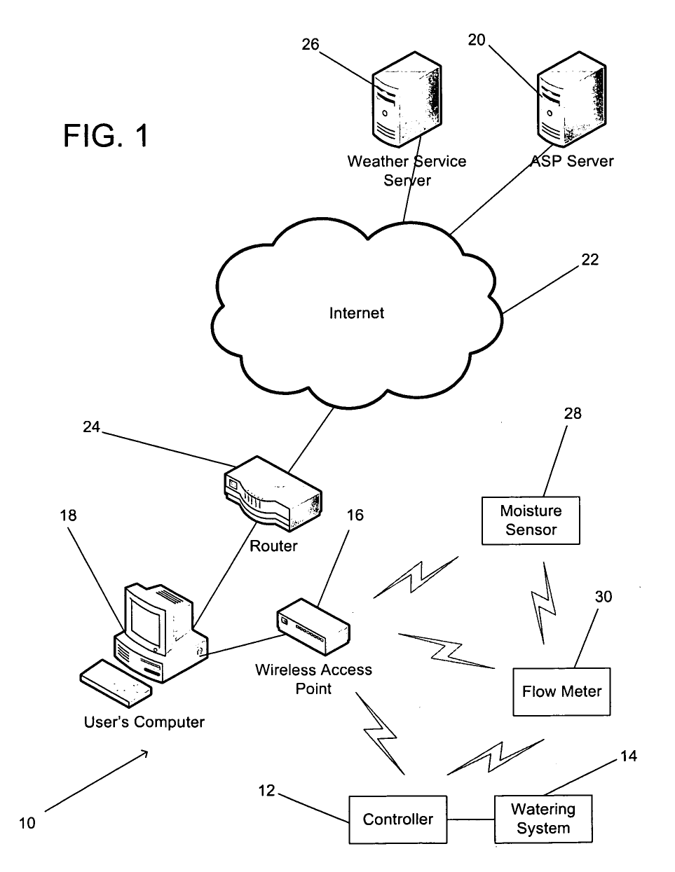

An irrigation control system in accordance with an embodiment of the invention is shown in FIG. 1. The irrigation control system 10 includes an irrigation controller 12 that is connected to an irrigation system 14. The irrigation controller 12 is also wirelessly connected to an access point 16. In a number of embodiments, the wireless connection is part of a mesh network, such as an IEEE 802.15.4 mesh network. A mesh network is typically characterized in that each node can act as a repeater extending the range of the network and can rapidly reconfigure to accommodate the failure of another node in the network. In other embodiments, other wired or wireless networking technologies that provide for bi-directional communication between the irrigation controller 12 and the access point 16 are used to connect the irrigation controller to an access point.

The access point 16 is connected to a user computer 18 via a wired link such as a USB FireWire, or Ethernet connection, or a wireless connection such as Bluetooth or via a 802.11b/g/n WiFi network. The user computer 18 is configured using a client application that enables the user to exchange information with the irrigation controller via the access point. In many embodiments, the client application enables the user to bind the irrigation controller to the user's computer so that other devices (i.e., a neighbor's computer) cannot communicate with the irrigation controller via an alternative access point. Once bound the irrigation controller can be configured with a baseline irrigation schedule. The baseline schedule can be a recommended schedule based upon the geographic location of the user, the soil type of each of the zones in the irrigation system, the slope of the land in each zone and/or the plants located within each zone. In many embodiments, the baseline watering schedule is manually configured and/or automatically modified based on geographic location to comply with local water restriction regulations. In a number of embodiments, the baseline schedule can vary based upon time of year.

Once a baseline irrigation schedule has been defined, the irrigation controller 12 can commence controlling the irrigation system 14. As part of the control process, the user computer 18 can retrieve weather information from the ASP server 20 via the Internet 22 or directly from a weather service server 26. In the illustrated embodiment, the user computer 18 is connected to the Internet via a router 24 that provides access to the Internet via an access provider. In a number of embodiments, the user computer 18 retrieves weather information from the ASP server 20 and uses the weather information to calculate adjustments to the baseline irrigation schedule and communicates these adjustments to the irrigation controller 12. For example, the user computer 18 can instruct the irrigation controller 12 to cease or reduce irrigation in response to a prediction of rain. Alternately, the user computer 18 can instruct the irrigation controller 12 to increase irrigation in response to predictions of unseasonably hot weather and/or modify a previously determined irrigation schedule in response to differences between predicted and actual weather conditions. In addition to modifying the baseline irrigation schedule, the client application can provide a user with a graphical illustration of the amount of water and/or money the user has saved over the baseline schedule and/or a conventional or previous irrigation schedule. An advantage of having a device other than the irrigation controller determine the modifications to the irrigation schedule is that the irrigation controller can be constructed as a much simpler and less expensive device. The cost of deploying a client application to a personal computer or to add the capabilities to the ASP server see discussion below) are comparatively low compared to the cost of providing an irrigation controller with sufficient hardware capabilities to handle the retrieval of weather data from a server and to perform the calculations involved in modifying the baseline irrigation schedule in response to the retrieved data.

In the illustrated embodiment, the ASP server 20 is connected to the Internet 22 and retrieves weather information for distribution to client applications on user computers 18 from one or more weather service servers 26. The weather information can include weather predictions and information concerning recorded weather conditions in one or more geographic locations. In other embodiments, the organization that maintains the ASP server 20 can independently collect weather information and make the information available to users via the ASP server 20.

The irrigation control system can also obtain information from a number of sensors. In the illustrated embodiment, the irrigation controller and/or the access point is able to communicate with a moisture sensor and a flow meter via the wireless mesh network. The moisture sensor can provide information concerning moisture content in the soil of an irrigation zone and the flow meter can provide information concerning the volume of water used during irrigation of a specific zone and detect malfunctions within the irrigation system 14. The information collected by the irrigation controller 12 using sensors can be used by the client application 18 to modify the baseline irrigation schedule. In other embodiments, other sensors such as temperature sensors, soil temperature sensors, wind speed sensors and rain gauges can be used to provide information concerning local weather conditions to an irrigation controller. Use of an optional mesh network enables the irrigation controller and each sensor to extend the wireless network beyond the access point. In other embodiments, other wired or wireless networking technologies can be used to provide information to the irrigation controller.

The above discussion describes an irrigation control system where a client application on a user computer modifies the baseline irrigation schedule. In many embodiments, the irrigation controller determines any modifications applied to the baseline irrigation schedule in response to weather information provided by the client application and sensor information. A limitation associated with the use of a client application to collect weather information, irrespective of whether the client application or the irrigation controller modifies the baseline irrigation schedule, is that the weather information is only available when the user computer is on and connected to the Internet. When weather information is unavailable, the baseline irrigation schedule can be modified based upon a watering index. The watering index is an estimate of the weather based upon historical information. In a number of embodiments, the baseline irrigation schedule automatically incorporates a watering index and no modification is required. An “always on” irrigation control system in accordance with embodiments of the invention can be provided using an access point that is directly connected to the network (i.e., not connected via a user computer). In a number of embodiments, the access point can include the “intelligence” of the client application and directly connected to the network. In other embodiments, the access point relays information to a remote application server and the application server determines modifications to the irrigation controller's irrigation schedule. In all configurations, the ability of the irrigation controller to record information concerning water usage and communicate the information to an application server when a connection is available enables water authorities to obtain regular updates concerning water usage patterns. In many instances, water usage information is as simple as a percentage variance from a baseline. When sensor information from volumetric sensors is available, water usage information can be specific volumes of water. In this way, the bi-directional capabilities of the local bi-directional communication network that includes the access point and the irrigation controller can be important to enabling many higher level capabilities of irrigation control systems in accordance with embodiments of the invention.

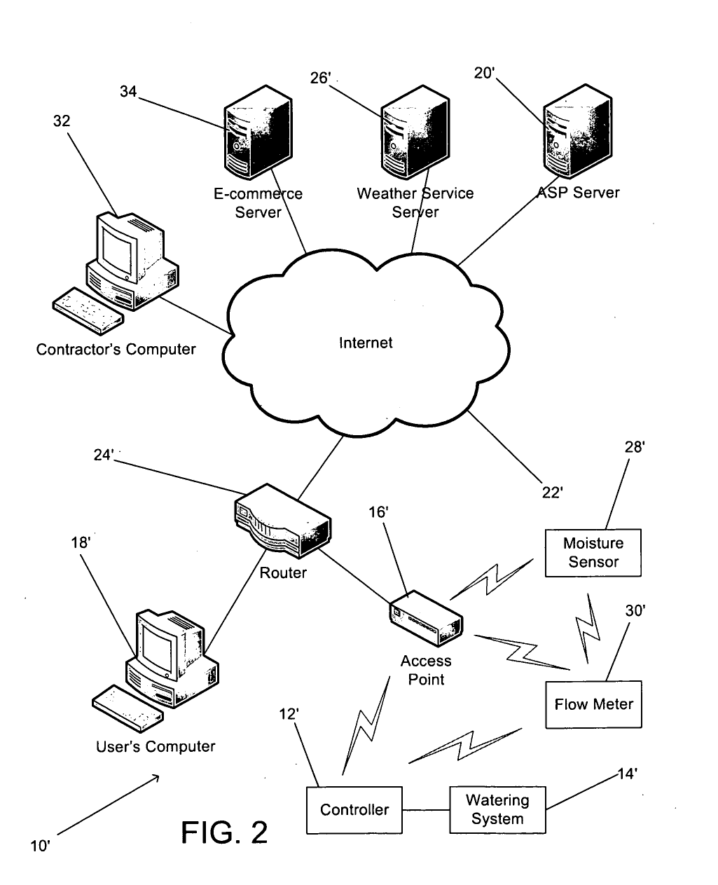

An embodiment of an irrigation control system that includes an access point that is directly connected to the Internet and configured to provide modifications to the irrigation schedule of an irrigation controller in accordance with an embodiment of the invention is shown in FIG. 2. The irrigation control system 10′ differs from the irrigation control system 10 shown in FIG. 1 in that the irrigation controller 12′ connects to an access point 16′ that is directly connected to a router 24′, which provides access to the Internet via an access provider. The irrigation controller 12′ binds with the access point and the client application discussed above is hosted by the access point to provide irrigation schedule modification information in response to weather information provided by the ASP server 20′. Decoupling the access point from the user's computer and shifting the processing load from the user computer to the access point 16′ enables the irrigation control system 10′ to consistently modify the irrigation schedule used by the irrigation controller 12′ in response to prevailing weather conditions. In other embodiments, the access point can simply relay information between an irrigation controller and an ASP server and the processing load is shifted to the ASP server without significantly increasing the hardware cost and/or complexity of the access point.

In the embodiment illustrated in FIG. 2, users can obtain information concerning their irrigation controllers 12′ via a user device 18′ using a web based interface. The illustrated user device is a personal computer, however, a user device includes a personal digital assistant, gaming consoles, a mobile phone, or any other device configured using an appropriate browser application. In a number of embodiments, the interface is provided by the access point 16′. The bi-directional nature of the communication between the access point 16′ and the irrigation controller 12′ means that information can be collected from the irrigation controller and aggregated by an ASP server 20′. The ASP server 20′ can support user accounts that provide information concerning multiple irrigation controllers. For example, a landscaping contractor with an Internet connected computing device 32 is able to set up an account to manage all of its client's irrigation controllers. In many embodiments, the ASP server 20′ provides users with access to information concerning water usage and the ability to modify the settings of the interrogation controller 12′ separately of any other interface that may be provided by a client application or by accessing the irrigation controller directly.

The exchange of information between irrigation controllers and ASP servers in irrigation control systems in accordance with embodiments of the invention creates additional opportunities to communicate with users. The ASP server 20′ associates irrigation controllers with user accounts and creates a permission structure that enables a user to grant permission to a second user to modify the irrigation schedule of irrigation controllers associated with the first user's account. In many embodiments, an ASP server provides information concerning the amount of money the user is saving as a result of installing an irrigation controller to a user via a web interface and/or via email. In several embodiments, an e-commerce server 34 that is connected to the Internet can use information aggregated by the ASP server to provide users with information concerning their gardens and/or promotional information, such as advertisements and/or coupons, for products or services relevant to the current needs of their gardens. The ASP server can also aggregate the information and provide the information to municipalities and/or control the water usage of users to ensure that the water usage complies with municipal water usage restrictions.

### Irrigation Controllers

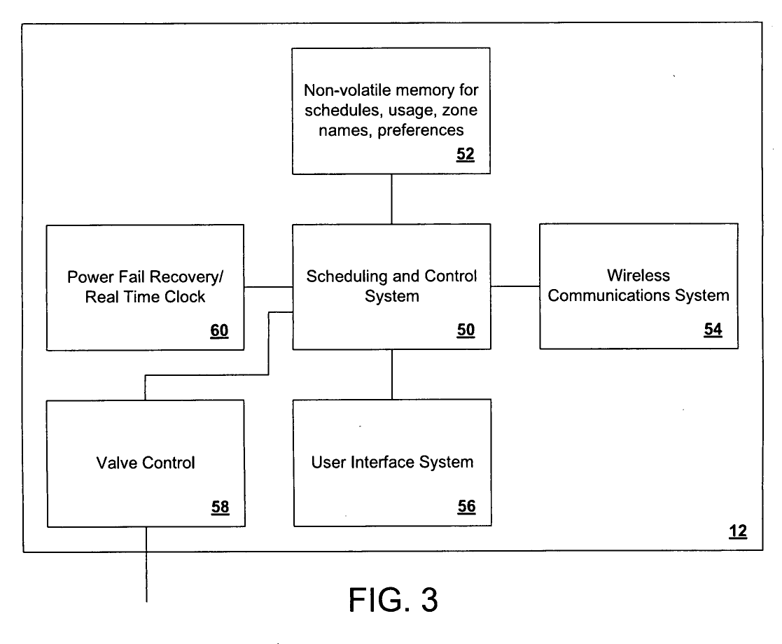

An irrigation controller in accordance with an embodiment of the invention is shown in FIG. 3. The irrigation controller 12 includes a scheduling and control system 50 that is connected to a non-volatile memory 52, a wireless communication system 54, a user interface system 56, a valve control interface 58, and a system clock and power failure recovery circuit 60. The scheduling and control system 50 handles all of the main functions of the irrigation controller including coordinating irrigation schedules, binding to and communicating with an access point via the wireless communication system 54 and conveying information to a user via the user interface system 56. Information concerning the baseline irrigation schedule, irrigation zones, access point information and user preferences are stored in the non-volatile memory 52. As discussed above, the wireless communication system 54 enables communication with an access point and sensors. In many embodiments, the wireless communication system conforms with the requirements of the IEEE 802.15.4 standard. The user interface system 56 typically includes an output device, such as a liquid crystal display, and an input device such as a keypad. The user interface system 56 enables the irrigation controller to provide information to the user about such things as irrigation zones and irrigation schedule. The valve control system 58 includes circuitry that can be used to activate conventional irrigation valves. In many embodiments, the valve control system 58 is such that the irrigation controller is designed as a direct replacement for a conventional control system. The power failure recovery and system clock circuitry 60 includes circuitry that maintains system time and coordinates the reinitialization of the system following a power failure. In many embodiments, the power failure recovery circuit includes a gel capacitor that enables sufficient charge storage to power the real time clock during a power failure. In other embodiments, a battery such as a rechargeable battery can be used to power the real time clock during a power failure. In many embodiments, the real time clock resets based upon information provided to the irrigation controller via the wireless communication system following a power failure. Although a specific embodiment of an irrigation controller is shown in FIG. 3, irrigation controllers in accordance with embodiments of the invention can be constructed in a variety of ways. In many embodiments, other combinations of components are used to achieve bi-directional communication with an access point, coordinate irrigation schedules, and actuate irrigation valves in accordance with the irrigation schedule.

### Access Points

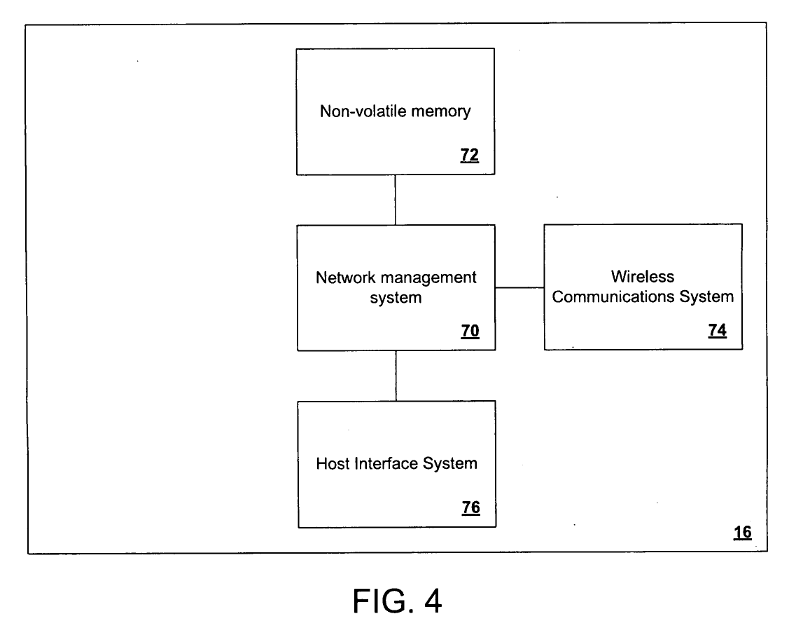

An access point in accordance with an embodiment of the invention is shown in FIG. 4. The access point 16 includes a network management system 70 connected to a non-volatile memory 72, a wireless communications system 74 and a host interface system 76. The network management system 70 coordinates the transfer of information between the host interface system 76 and one or more irrigation controllers via the wireless communications system 74. The non-volatile memory includes information concerning the members of the network (i.e., irrigation controllers and/or sensors) that have been bound to the access point and the topology of the network. In many embodiments, the host interface system 76 includes one or more of a serial RS-232 interface, a USB interface, an 802.11b/g/n interface, an Ethernet interface and/or a modem for connecting to a POTS network, a digital network and/or a mobile telephone network. Although a specific implementation of an access point is shown in FIG. 4, other implementations that facilitate connection between a user computer and/or a networked device such as an ASP server and one or more irrigation controllers can be used in accordance with embodiments of the invention.

### Client Applications

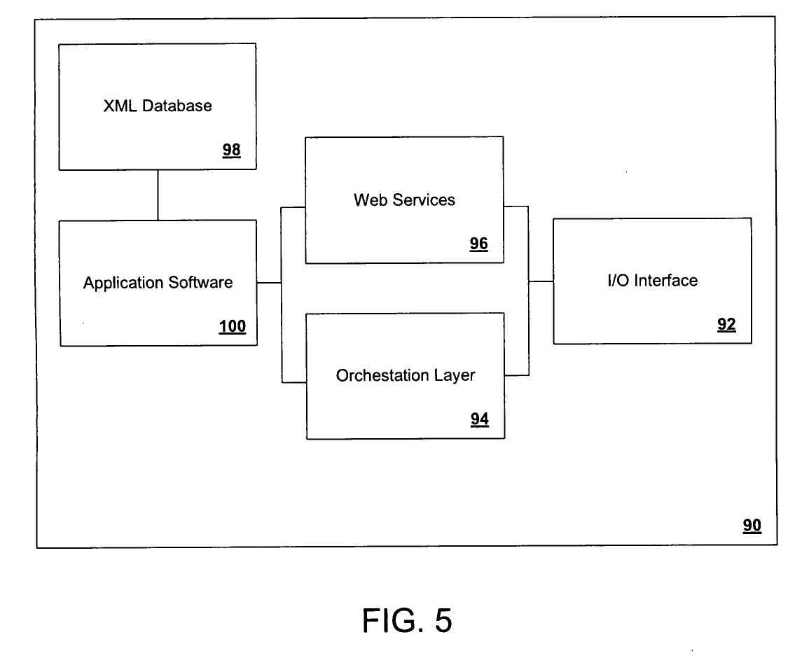

A client application in accordance with an embodiment of the invention is conceptually illustrated in FIG. 5. The client application 90 includes an I/O interface module that handles the transmission of information relating to the irrigation system to and from the computing device on which the client application is installed. As discussed above, the computing device can be a user computer, an access point or an ASP server. Two modules utilize the I/O interface and they are the orchestration layer 94 and the web services module 96. The orchestration layer 94 coordinates all communication with devices bound to an access point. In embodiments that use an IEEE 802.15.4 mesh network, the orchestration layer 94 sits above the implementation of the mesh network and abstracts communication with devices bound to the mesh network. The web services module 96 includes an HTML server and is utilized by the client application to provide a web based user interface. The web services module 96 also enables the client application to access other sources of information via the Internet, including servers of weather organizations. The client application 90 includes application software 100 which coordinates the activities of the client application including modifying irrigation schedules and providing the modified schedules to irrigation controllers via the orchestration layer 94 and providing an interactive user interface via the web services module 96. Many of the functions of the application software rely upon information stored in a database 98. In the illustrated embodiment, the database 98 is an XML database and includes information concerning user accounts, irrigation schedules and resource information enabling the determination of baseline watering schedules such as information concerning plant watering requirements, historical weather information by geographic location, and/or municipal water usage restrictions. In other embodiments, the database 98 can include other information that is of assistance to the client application in establishing and modifying irrigation schedules. Although a specific implementation of a client application is illustrated in FIG. 5, other implementations in accordance with embodiments of the invention can be used including implementations that are customized for use on a user computer, implementations that are customized for use with an access point and implementations that are customized for use with multiple users via an ASP server.

### Setting Up an Irrigation System

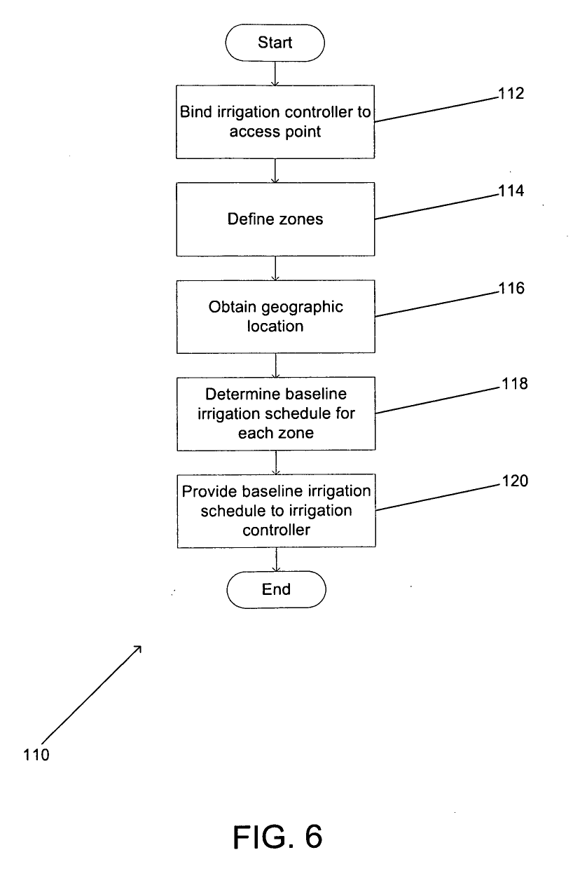

A process for setting up an irrigation controller in accordance with an embodiment of the invention is shown in FIG. 6. The process 110 includes binding [112] an irrigation controller to a client application, and defining [114] the irrigation zones served by the irrigation system controlled by the irrigation controller. The definition of the irrigation zones can include providing a name for the irrigation zone [in one or more languages], information concerning the type of irrigation system, the plants within the irrigation zone, the soil type, the grade of the zone [i.e., potential for runoff], and/or any other information relevant to determining the irrigation requirements of the zone. In addition to defining irrigation zones, the process involves obtaining [116] the geographic location of the irrigation system. In many embodiments, a zip code is provided. In other embodiments, a street address or other geographic information is provided. The geographic information and the definition of the zones can then be used to determine [118] a baseline irrigation schedule for each zone, which is provided [120] to the irrigation controller and the irrigation controller. At which point, the irrigation controller is ready for operation.

In a number of embodiments, interactions with the user are coordinated by a client application on a user computer. In other embodiments, the interactions are coordinated by an ASP server via the Internet.

### Binding Irrigation Controllers

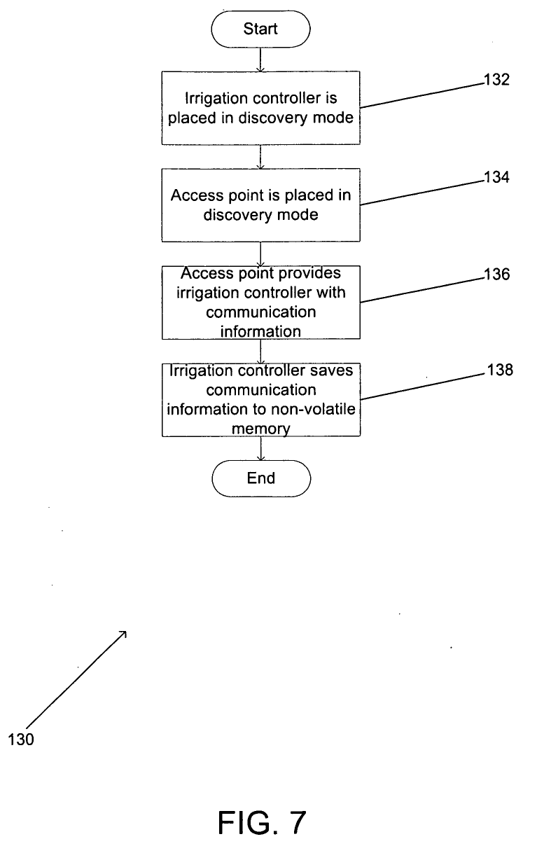

A process for binding an irrigation controller or other component of an irrigation system to a client application [i.e., a user computer, access point or ASP server] in accordance with an embodiment of the invention is shown in FIG. 7. The process 130 includes placing [132] an irrigation controller in discovery mode. In many embodiments, irrigation controllers are not associated with any client application at power up and broadcast a “looking for host” message. As part of the process, a client application is placed [134] in setup mode. Only a host that is in setup mode can act on “looking for host” messages. The access point and the irrigation controller can then discover each other. In many embodiments, a user instruction is required before binding can proceed. Once binding commences, the client application provides [136] the irrigation controller with communication information that the irrigation controller saves to [138] non-volatile memory. In several embodiments, the irrigation controller acknowledges that the communication information has been saved to the client application that is now its host. In many embodiments, the communication information is a unique 64 bit number that is provided to each device in hardware. This number is typically only used for discovery and binding and is different from any MAC address used in the network layers.

Once the client application has received the acknowledgement, the client application can store information concerning the bound device in a local database, enabling the user to control the device via the client application. In a number of embodiments, the client application can bind other devices to devices already bound to the client application. For example, a moisture sensor can be bound to an irrigation controller and messages from the moisture sensors are directly transmitted to the irrigation controller when the host is offline or unavailable.

During Large scale power failures, the irrigation controller will restart and use the communication information to reconnect with the client application to which it is bound. In this way, binding of an irrigation controller to a neighbor's client application can be avoided in circumstances where multiple irrigation control systems are used in a locality and the irrigation systems lose power simultaneously. Although a specific binding protocol is illustrated in FIG. 7, other binding protocols that limit an irrigation controller to communicating with a single client application can be used in accordance with embodiments of the invention.

### Watering Cycles

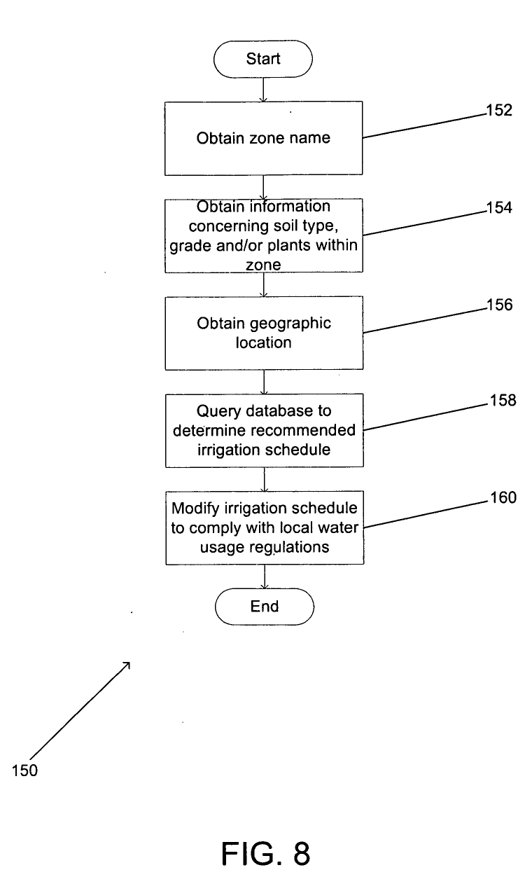

A process for defining irrigation zones and developing a baseline irrigation schedule in accordance with an embodiment of the invention is shown in FIG. 8. The process 150 includes obtaining [152] zone names, and obtaining [154] information concerning soil type, grade and/or plants within each zone, and obtaining [156] geographic information. A database including reference information concerning watering requirements of different plant types and weather information concerning different geographic areas is then queried and the results used in combination with the obtained information to determine a baseline irrigation schedule that will meet the irrigation requirements of the plants within each watering zone. In several embodiments, the baseline irrigation schedule is modified [160] to comply with municipal watering restrictions. In many municipalities, restrictions apply concerning the amount of water that can be used for irrigation, the days on which irrigation can be performed and/or the time of day at which irrigation can be performed. In several embodiments, the baseline irrigation schedule is modified to comply with the irrigation restrictions. In circumstances where the irrigation system cannot be modified to comply with the municipal restrictions, a warning can be provided to the user including information concerning the plants that could be replaced to reduce water consumption. In other embodiments, other processes for determining baseline irrigation schedules can be used in accordance with embodiments of the invention.

The process shown in FIG. 8 relates to establishment of an irrigation schedule during initialization of an irrigation system. An irrigation schedule can be updated to reflect addition of new plants and/or other modifications to the zones or irrigation system. In a number of embodiments, an irrigation schedule can be modified to incorporate special irrigation requirements associated with a discrete event, such as laying new turf or application of fertilizer. In many embodiments, a user interface is provided that simply enables the user to indicate that specific discrete event has occurred and the system automatically adjusts the irrigation schedule in accordance with the requirements of the specific event and automatically returns the irrigation schedule to normal once the special watering requirements have been satisfied. In several embodiments, the user interface enables the user to manually set the modifications to the irrigation requirements associated with the discrete event. The processing capabilities of irrigation controllers in accordance with embodiments of the invention also enable the definition of specialized irrigation cycles. For example, specific cycles can be provided for drip systems and spray and soak cycles, which involve bursts of irrigation followed by pauses to enable water to soak into the soil, can be provided to avoid runoff in sloped zones. In addition, irrigation systems in accordance with embodiments of the invention can periodically survey a user to ascertain whether the user believes zones are receiving too much or too little water and modify the baseline irrigation schedule accordingly.

### Weather Updates

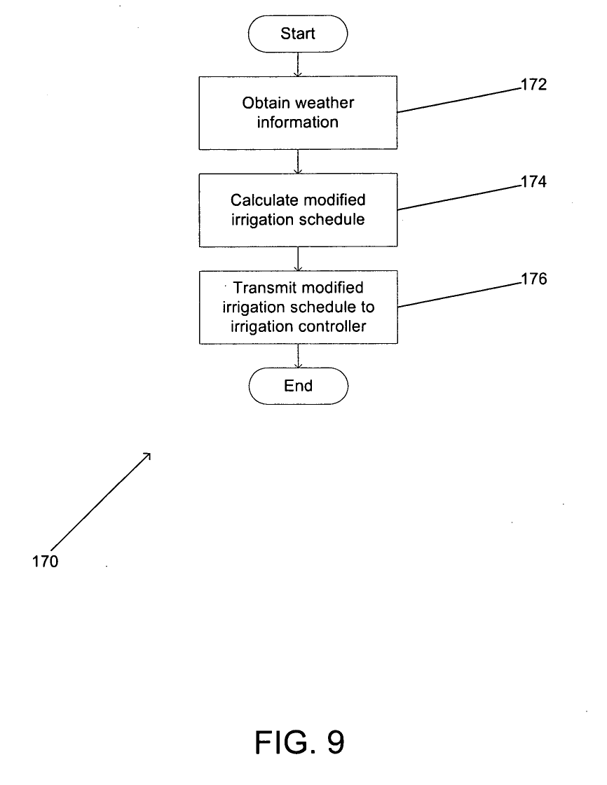

A process for modifying a baseline irrigation schedule in response to weather information is shown in FIG. 9. The process 170 includes obtaining [172] weather information. The weather information can be obtained from a private weather sensing network or from a weather service. Once the weather information has been obtained, the irrigation schedule can be modified in anticipation of predicted weather conditions and to accommodate variation between actual weather and previous predictions of the weather. In many embodiments, temperature and humidity predictions are used to determine the modifications to apply to the baseline irrigation schedule. One embodiment modifies the amount of irrigation for every 5 degree variation in the forecast temperature from the average temperature of the hottest month of the year and also modifies the amount of irrigation for every 5% variation in the forecast humidity from the average annual humidity. The amount of variation can be a default amount and, in many embodiments, the user can set the amount of variation to apply. In a number of embodiments, the user sets the high temperature and average humidity and the amount of irrigation at the high temperature and average humidity. In other embodiments, the amount of irrigation is determined based upon information concerning plant type, soil type and historical weather conditions and/or alternative schemes can be used to modify the amount of irrigation in response to variations in temperature and humidity. In several embodiments, modifications are also made in response to wind speed information. In other embodiments, various other weather parameters are used when modifying the baseline irrigation schedule. In several embodiments, theories concerning evapotranspiration are used to modify the irrigation schedule based upon temperature, humidity and soil temperature measurements and/or predictions. Once modifications have been determined, the new irrigation schedule is transmitted [176] to the relevant irrigation controller(s).

When the irrigation controller relies upon a user computer to obtain weather information, the irrigation controller is unable to obtain modifications when the user computer is switched off or is not connected to the Internet. In which case, the irrigation controller simply uses the baseline irrigation schedule. When the irrigation controller obtains weather based modifications to its irrigation schedule from an access point or an ASP server, the likelihood that the irrigation controller is able to obtain modifications is higher due to almost continual network availability.

### Reflashing an Irrigation Controller

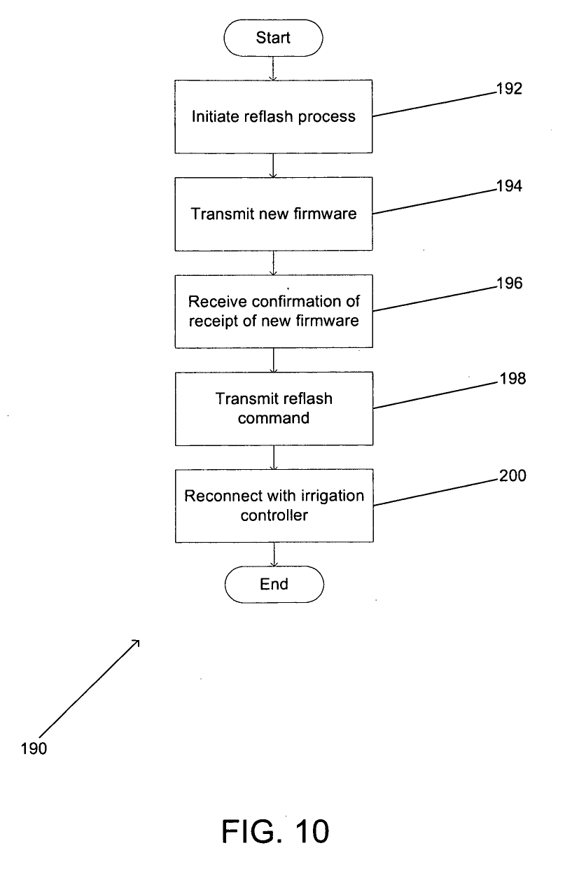

The bi-directional nature of the communication link between the access point and the irrigation controller enables updating of the irrigation controller firmware. A process for updating an irrigation controller's firmware (i.e., reflashing the irrigation controller) is shown in FIG. 10. The process 190 includes initiating [192] the reflashing process by sending a message to the irrigation controller to prepare the irrigation controller for the transmission of new firmware. New firmware is transmitted [194] to the irrigation controller and the irrigation controller confirms [196] the receipt of the firmware. In confirming receipt, the irrigation controller can check for errors in the firmware using any of a variety of error correction processes including performing one or more checksums on the received firmware. When the accurate receipt of the firmware is confirmed, an instruction is transmitted [198] to the irrigation controller to commence the firmware upgrade. The irrigation controller copies the received firmware update into the relevant location [typically an EEPROM] and the irrigation controller reboots. Once the irrigation controller has rebooted, the irrigation controller retrieves communication information from its non-volatile memory and reconnects [200] to the access point to which it is bound. In the event that a reflash goes awry, many irrigation controllers include use a combination of keys as a reset button that restores the factory default firmware of the irrigation controller. Although a specific process is shown in FIG. 10, other firmware update processes in accordance with embodiments of the invention can be utilized in accordance with embodiments of the invention.

### Marketing

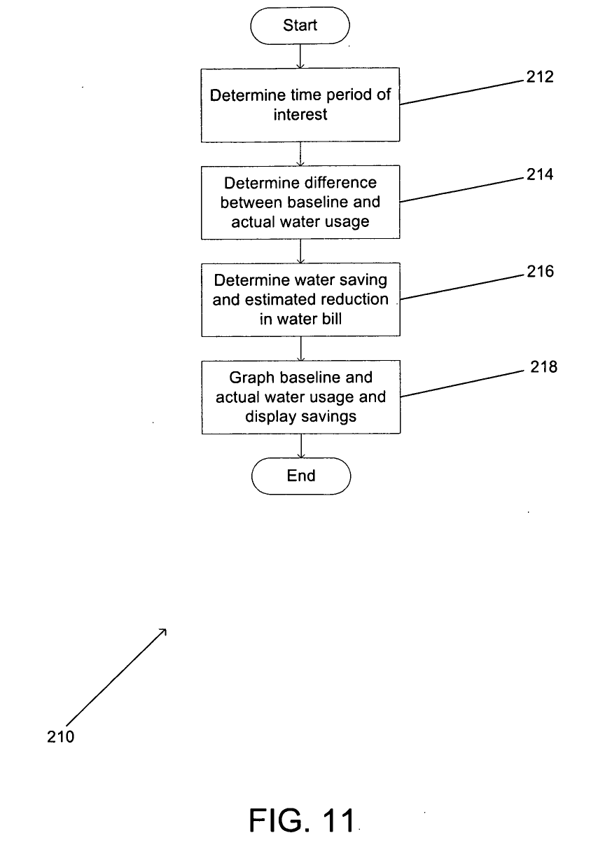

Many embodiments of the invention include a user interface that provides a user with information concerning the operation of the irrigation system. In several embodiments, the user interface provides the user with graphical information concerning water usage and/or water savings that have resulted from the use of the system. In a number of embodiments, the savings are calculated in comparison to a typical watering schedule, and/or the baseline irrigation schedule. A process for generating a graphical representation of water savings in accordance with an embodiment of the invention is shown in FIG. 11. The process 210 includes determining [212] a time period of interest. In a number of embodiments, the time period is a default period such as one year or since installation of the irrigation system. In several embodiments, the user can choose a time period from a number of default time period selections and/or specify a time period of interest. The irrigation system then determines [214] the difference between the baseline water usage and actual water usage over that time period [i.e., the water savings due to adjustments for weather]. In several embodiments, the volume of water saved is used to calculate an approximate currency equivalent of the savings using information concerning municipal water rates. The baseline water usage, actual water usage and cost savings are then displayed [218] graphically. In other embodiments, information concerning savings can be communicated in a variety of ways including via an email report every month or other period.

### Aggregation of Information by ASP Servers

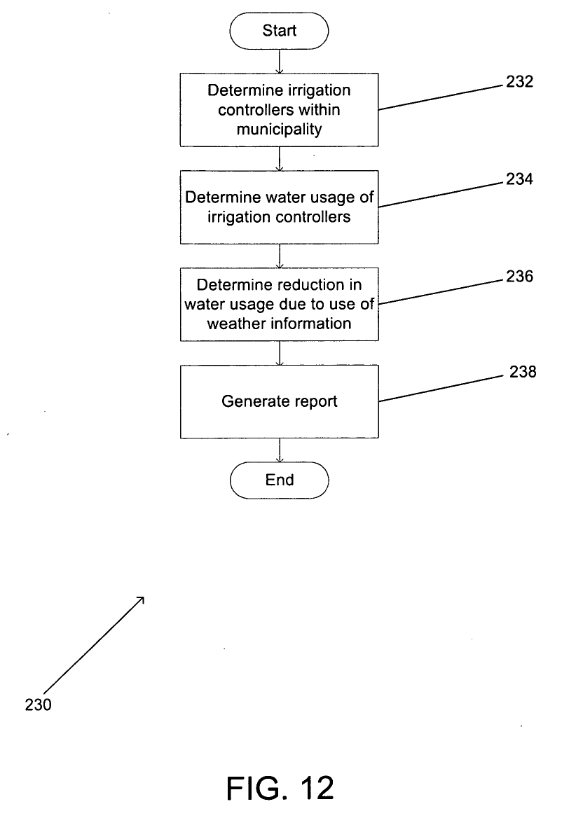

Transmission of information concerning irrigation schedules between irrigation controllers and ASP servers in several embodiments and between client applications and servers in many embodiments enables the aggregation of information at an ASP server. The aggregated information can be used for a variety of purposes including reporting water usage to municipal authorities. A process for reporting aggregate water usage is shown in FIG. 12. The process 230 includes determining [232] the irrigation controllers known to the ASP server that are within a municipality. The ASP server then determines [234] the total water usage of the identified irrigation controllers and, in a number of embodiments, determines [236] the amount of water saved due to modification of irrigation schedules in response to weather information in accordance with embodiments of the invention. A report is then generated [238] and can be forwarded to a municipality for its records. In many embodiments, water usage can be aggregated for an entire state, city, street, or home. In other embodiments, additional information can be included in the report including information concerning the types of plants being irrigated and/or any other information relevant to developing water policy. In a number of embodiments, aggregated information is used for a number of purposes including for developing marketing strategies.

### Updating Irrigation Schedules in Response to New Regulations

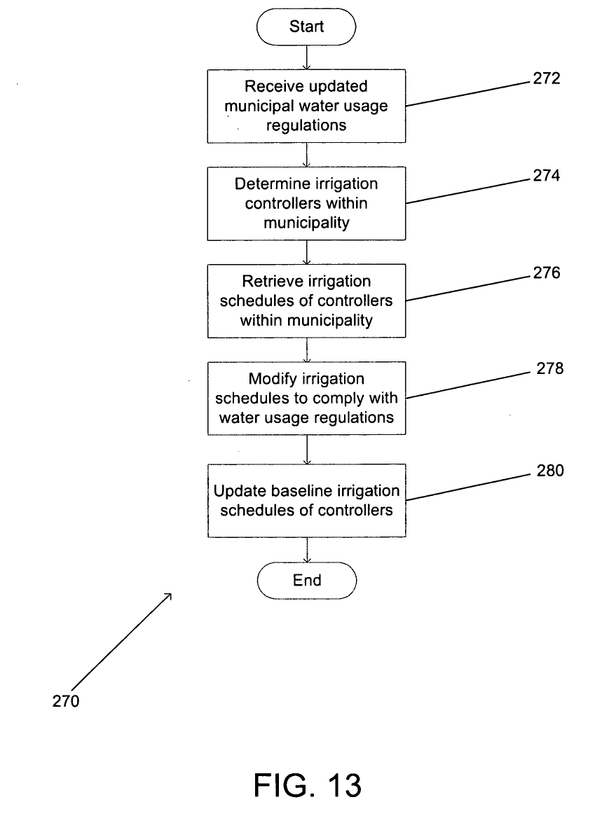

The ability of an ASP server to communicate with a number of irrigation controllers and/or client applications provides the ability of a municipality to distribute and impose new watering regulations via an ASP server. In many environments irrigation water is obtained from remote geographic locations [e.g., communities fed by the Colorado River] and watering regulations may change in response to macro water usage patterns in addition to local weather conditions. When water regulations change, the new water regulations can be provided to an ASP server and the new regulations used to modify the baseline irrigation schedule of all irrigation controllers known to the ASP server. A process for updating the irrigation schedule of an irrigation controller in response to modifications to water usage regulations is shown in FIG. 13. The process 270 includes receiving (272) updated water usage regulations, and determining [274] irrigation controllers and/or client applications impacted by the new regulations. For irrigation systems that include a client application, the new regulations can be communicated to the client application. When the irrigation controller is connected via an access point that communicates directly with an ASP server, the ASP server can retrieve [276] information concerning the irrigation controller's baseline irrigation schedule, modify [278] the irrigation schedule to comply with the new regulations and provide [280] the updated schedule to the irrigation controller. In many embodiments, the ASP server and/or the client application provides users with notification of the change in watering regulations and impact that the changes may have on specific plants in specific zones.

### Web Based User Interfaces

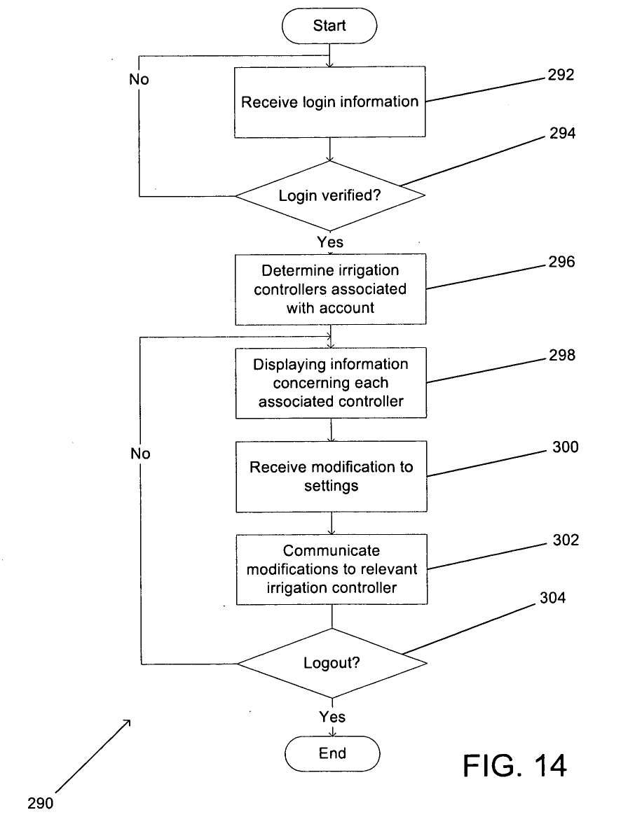

Information concerning one or more irrigation controllers can be provided via a web based user interface. The user interface can be generated by a client application (hosted on either a user computer or an access point). In other embodiments, the web based user interface is provided by an ASP server. In a number of embodiments, a user can establish an account that includes multiple irrigation controllers. In several embodiments, a single user can create an account including irrigation controllers bound to a variety of client applications. An example of such an account is an account established by a landscaping contractor that is provided with authorization from a number of clients to control the client's irrigation systems. In several systems, the server maintains a system for granting permissions to control the irrigation controllers associated with a user account. Providing a system of permissions can be important for supporting the ability of homeowners, landscape contractors, and water authorities to modify irrigation schedules in defined ways. A process for providing information via a web interface is shown in FIG. 14. The process 290 includes receiving [292] login information. A determination [294] is made as to whether the login information can be verified and, assuming the login information is correct, the user is provided with access to account information. A determination [296] is made as to the irrigation controllers associated with the account and information concerning each associated irrigation controller is displayed [298] in a format viewable via a web browser. The user is able to modify [300] settings associated with the irrigation controllers and the modifications are communicated [302] to the relevant client applications) associated with the irrigation controllers). The process continues to provide the user with information and update the irrigation controllers until the user logs out [304] of the user's account or the process times out due to inactivity. In other embodiments, other interfaces can be provided including interfaces that are accessible via personal digital assistances and mobile phones.

### Marketing Platforms

Information collected concerning individual irrigation systems and aggregated information concerning irrigation systems within a particular geographic area [or linked by another unifying characteristic] can be used to provide users with relevant information concerning their garden or irrigation needs and/or promotional materials concerning products and/or service relevant to their current garden or irrigation needs. In many embodiments, the information and/or promotional material are modified based upon a user's profile. For example different information and/or promotional material can be provided to property owners and landscape contractors. The information and/or promotional material can be provided via e-mail or in conjunction with a web based user interface.

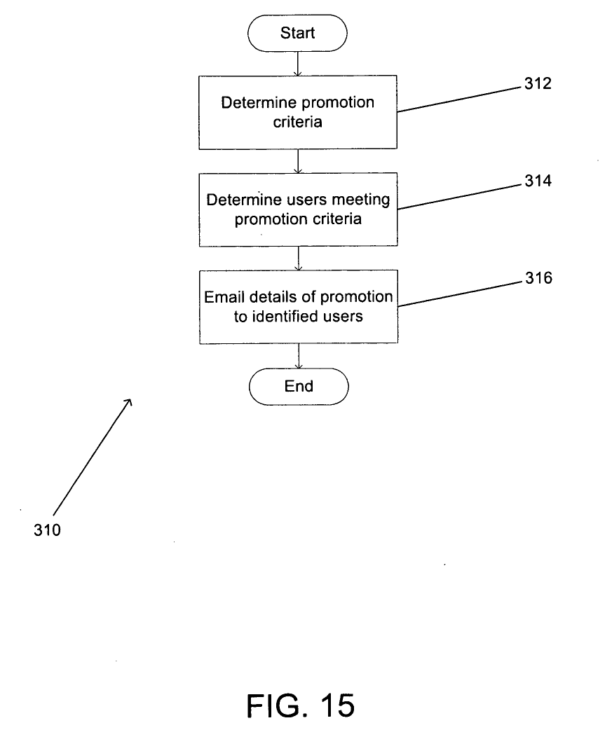

A process for distributing relevant information and/or promotional material via e-mail is shown in FIG. 15. The process 310 includes determining [312] criteria for identifying users to whom a particular information bulletin and/or promotion is relevant. Based upon the criteria, a determination [314] is made concerning the users that meet the criteria and emails including the information bulletin and/or promotion are distributed (316) to the identified users.

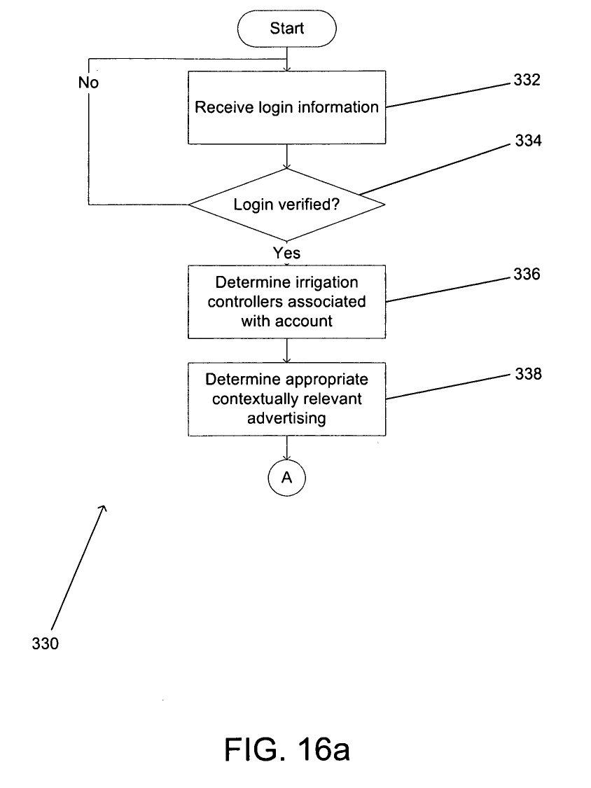

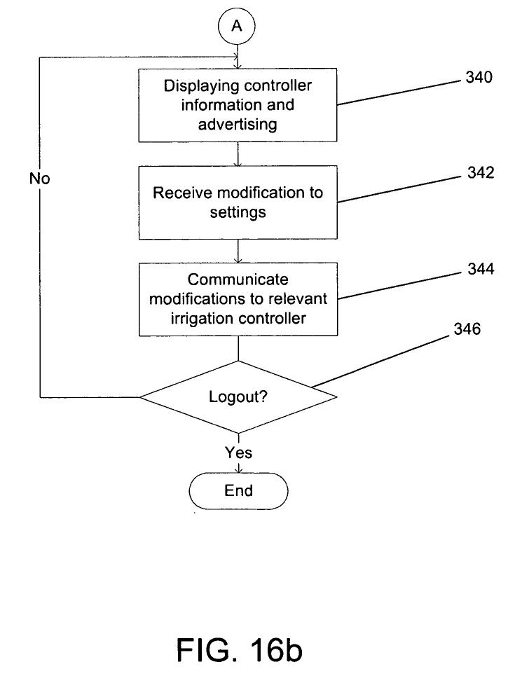

A process for providing contextually relevant information within a web based user interface in accordance with an embodiment of the invention is shown in FIGS. 16a and 16b. The process 330 is similar to the process shown in FIG. 14 with the addition that a determination (338) is made concerning information bulletins and/or advertising that is relevant to the specific user viewing an account via the web interface. When the user interface is displayed to the user, the information bulletins and/or advertising can be incorporated into the pages to present (340) the bulletins and/or advertising with information concerning the user's irrigation system(s).

In a number of embodiments information bulletins and contextually relevant advertising is served to the user via an e-commerce server that is separate from the ASP server. In several embodiments, the ASP server provides the e-commerce server with information in addition to the information displayed within a specific page of a user interface to help the e-commerce server further tailor information bulletins and/or promotions to the anticipated needs of the user. Although specific marketing techniques are identified above, other marketing strategies that utilize information retained by an ASP server can be implemented in accordance with embodiments of the invention via a number of communication channels including direct mailings, text messages, e-mail communications and/or via a user interface provided by the ASP server. As an example, rebates and promotions can be provided to a user as part of the initial set up of an irrigation system in accordance with an embodiment of the invention.

While the above description contains many specific embodiments of the invention, these should not be construed as Limitations on the scope of the invention, but rather as an example of one embodiment thereof. Accordingly, the scope of the invention should be determined not by the embodiments illustrated, but by the appended claims and their equivalents.

What is claimed is:

1. An irrigation control system, comprising:
an irrigation controller configured to control an irrigation system, where the irrigation controller is configured to communicate with an access point via a local bi-directional communication network;
a personal computer connected to the access point and to a communication network, where the personal computer is configured to communicate with the irrigation controller via the access point;
a weather server configured to communicate with the personal computer via the communication network;
an application server configured to communicate with the personal computer via the communication network; and
a user device configured to communicate with the application server via the communication network;
wherein the irrigation controller is configured with a baseline schedule for controlling the irrigation system;
wherein the irrigation controller is configured to maintain information concerning water usage;
wherein the personal computer is configured to obtain weather information from the weather server, modify the baseline irrigation schedule using at least the weather information, and to provide the irrigation controller with the modified irrigation schedule via the access point;
wherein the personal computer is configured to obtain information including water usage information from the irrigation controller via the access point;
wherein the application server is configured to obtain information including information concerning water usage of an irrigation controller from the personal computer via the communication network; and
wherein the user device is configured to obtain information including information concerning water usage of the irrigation controller from the application server via the communication network.

2. The irrigation control system of claim 1, wherein the irrigation controller is associated with a user account maintained by the application server.

3. The irrigation control system of claim 2, wherein:
the server maintains access information associated with the user account; and
the user device is configured to access the user account using the access information and to obtain user account information from the application server.

4. The irrigation control system of claim 3, wherein:
the application server obtains the current irrigation schedule of the irrigation controller from the personal computer via the communication network;
the user device is configured to retrieve the current irrigation schedule of the irrigation controller from the application server and to provide the application server with a modified irrigation schedule via the communication network;
the application server is configured to provide the modified irrigation schedule to the personal computer via the communication network; and
the personal computer is configured to provide the modified irrigation schedule to the irrigation controller via the access point.

5. The irrigation control system of claim 2, further comprising:
at least one additional irrigation controller configured to communicate with the access point via the LOCAL bi-directional communication network;
wherein the at least one additional irrigation controller is also associated with the user account;
wherein the application server is configured to obtain information including information concerning water usage of each of the at least one additional irrigation controllers from the personal computer; and
wherein the application server is configured to aggregate water usage information across all of the irrigation controllers associated with the user account.

6. The irrigation control system of claim 2, further comprising:
a second irrigation controller configured to communicate with a second access point via a second local bi-directional communication network; and
a second personal computer connected to the second access point and to the communication network, where the second personal computer is configured to communicate with the second irrigation controller via the second access point;
wherein the application server is configured to obtain information including information concerning water usage of the second irrigation controller from the second personal computer; and
wherein the second irrigation controller is associated with a second user account maintained by the application server.

7. The irrigation control system of claim 6, wherein the application server is configured to aggregate water usage information across multiple user accounts.

8. The irrigation control system of claim 6, wherein:
the server maintains access information associated with a third user account;
the first and second user accounts include permission information granting the third user account access to irrigation controllers associated with a user account; and
the user device is configured to access the third user account using the access information and to obtain information concerning the first and second irrigation controllers from the application server.

9. The irrigation control system of claim 8, wherein:
the user device is configured to retrieve the current irrigation schedule of the second irrigation controller from the application server and to provide the application server with a modified irrigation schedule for the second irrigation controller via the communication network;
the application server is configured to provide the modified irrigation schedule to the second personal computer via the communication network; and
the second personal computer is configured to provide the modified irrigation schedule to the second irrigation controller via the second access point.

10. The irrigation control system of claim 6, wherein:
the server maintains geographic information concerning each irrigation controller; and
the server is configured to aggregate water usage information across all irrigation controllers within a geographic area.

11. The irrigation control system of claim 2, wherein:
each user account includes associated contact information; and
the server is configured to determine information relevant to the user based upon the user account information and provide the information to the user using the contact information.

12. The irrigation control system of claim 1 wherein:
the server is configured to provide the personal computer with one or more irrigation limits via the communication network; and
the personal computer is configured to generate a limited baseline irrigation schedule that does not violate the one or more irrigation limits and to provide the limited baseline schedule to the irrigation controller via the access point.

13. The irrigation control system of claim 12, wherein the personal computer is configured to modify the limited baseline irrigation schedule in response to weather information so that the modified irrigation schedule does not violate the one or more irrigation limits.

14. The irrigation control system of claim 1, wherein the weather server and the application server are the same server.

15. The irrigation control system of claim 1, further comprising at least one sensor configured to communicate sensor information to the access point via the local bi-directional communication network; and
wherein the personal computer is configured to update the baseline irrigation schedule using at least the sensor information received via the access point.

16. The irrigation control system of claim 15, wherein at least one of the sensors is a moisture sensor.

17. The irrigation control system of claim 16, wherein at least one of the sensors is a flow meter.

18. The irrigation control system of claim 1, wherein the personal computer is configured to graphically display water savings achieved through modifications to the baseline irrigation schedule.

19. The irrigation control system of claim 1, wherein:
the irrigation controller includes an erasable non-volatile memory containing firmware;
the application server is configured to distribute new firmware for the irrigation controller to the personal computer via the communication network;
the personal computer is configured to provide the new firmware to the irrigation controller via the access point; and
the irrigation controller is configured to load the new firmware into the erasable non-volatile memory.

20. An irrigation control system, comprising:
an access point connected to a communication network via a router;
an irrigation controller configured to control an irrigation system, where the irrigation controller is configured to communicate with an access point via a local bi-directional communication network;
a weather server configured to communicate with the access point via the communication network;
an application server configured to communicate with the access point via the communication network; and
a user device configured to communicate with the application server via the communication network;
wherein the irrigation controller is configured with a baseline irrigation schedule for controlling the irrigation system;
wherein the irrigation controller is configured to maintain information concerning water usage;
wherein the access point is configured to obtain weather information from the weather server via the router, modify the baseline irrigation schedule using at least the weather information, and to provide the irrigation controller with the modified irrigation schedule via the local bi-directional communication network;
wherein the access point is configured to obtain information including water usage information from the irrigation controller via the local bi-directional communication network;
wherein the application server is configured to obtain information including information concerning water usage of an irrigation controller from the access point via the communication network; and
wherein the user device is configured to obtain information including information concerning water usage of the irrigation controller from the application server via the communication network.

21. An irrigation control system, comprising:
an access point connected to a communication network via a router;
an irrigation controller configured to control an irrigation system, where the irrigation controller is configured to communicate with an access point via a local bi-directional communication network;
an application server configured to communicate with the access point via the communication network;
a weather server configured to communicate with the application server via the communication network; and
a user device configured to communicate with the application server via the communication network;
wherein the irrigation controller is configured with a baseline irrigation schedule for controlling the irrigation system;
wherein the irrigation controller is configured to maintain information concerning water usage;
wherein the application server is configured to obtain weather information from the weather server, modify the baseline irrigation schedule using at least the weather information, and to provide the irrigation controller with the modified irrigation schedule via the access point;
wherein the application server is configured to obtain information including information concerning water usage from the irrigation controller via the access point; and
wherein the user device is configured to obtain information including information concerning water usage of the irrigation controller from the application server via the communication network.
